(19) United States
(12) Patent Application Publication
(10) Pub. No.: US 2014/0377439 A1
(43) Pub. Date: Dec. 25, 2014

(54) LOW-PROTEIN FROZEN CONFECTIONERY PRODUCT

(71) Applicant: ARLA FOODS AMBA, Viby j (DK)

(72) Inventors: Allan Eriksen, Herning (DK); Bjørn Baldursson, Hasselager (DK)

(73) Assignee: ARLA FOODS AMBA, Viby J (DK)

(21) Appl. No.: 14/375,725

(22) PCT Filed: Feb. 6, 2013
(86) PCT No.: PCT/EP2013/052347

§ 371 Date: Jul. 30, 2014

(30) Foreign Application Priority Data
Feb. 6, 2012 (EP) 12154055.3

(51) Int. Cl. A23G 9/40; A23G 9/52

(52) U.S. Cl. CPC A23G 9/40; A23G 9/52; A23V 2002/00
USPC 426/565

(57) ABSTRACT

The present invention relates to frozen confectionery products. In particular the present invention relates to low-protein frozen confectionery products having a protein content within the range of 0.050-1.25% w/w and an edible fat content of at least 5% w/w, where neither organoleptic properties nor the melting property of the frozen confectionery product have been compromised.

### TECHNICAL FIELD OF THE INVENTION

The present invention relates to frozen confectionery products. In particular the present invention relates to a low-protein frozen confectionery product having a protein content within the range of 0.050-1.25% w/w and an edible fat content of at least 5% w/w.

### BACKGROUND OF THE INVENTION

Due to shortage, the milk protein price has increased dramatically in recent years, threatening to create a snowball effect unto various types of food and food products in which it is a key ingredient. The frozen confectionery industry and other food manufactures are under pressure because there is no sign that the prices will come down.

To reduce production costs, and hence maintain or even lower the market price, one may try to lower the protein content of a frozen confectionery product. However, this results in poor quality with regard to creaminess, organoleptic and/or melting properties.

### SUMMARY OF THE INVENTION

Hence, it is an object of the present invention to provide a frozen confectionery product that solves or alleviates the above mentioned problems.

More particularly, it is an object of the present invention to provide a frozen confectionery product with a low protein content. The frozen confectionery product should preferably resemble a corresponding frozen confectionery product with normal levels of protein, especially with regard to the organoleptic and/or melting properties.

Thus, one aspect of the invention relates to a method for producing a low-protein frozen confectionery product having a protein content within the range of 0.050-1.25% w/w and an edible fat content of at least 5% w/w, said method comprising the steps of:
a) providing a base composition comprising:
   i. an ingredient mix comprising:
      1. a microparticulated whey protein material having a denaturation degree within the range of 5-80%, and
      2. a calcium chelating agent
   ii. an edible fat source
   iii. an emulsifying agent
   iv. water,
b) mixing said base composition to obtain an emulsified mixture, and
c) freezing said emulsified mixture to obtain the low-protein frozen confectionery product.

Another aspect of the present invention relates to a low-protein frozen confectionery product having a protein content within the range of 0.050 to 1.25% w/w and an edible fat content of at least 5% w/w, said frozen confectionery product comprising:
i. an ingredient mix comprising:
   1. a microparticulated whey protein material having a denaturation degree within the range of 5-80%, and
   2. citrate calcium chelating agent
ii. one or more edible fat sources
iii. one or more emulsifying agents, and
iv. water.

Yet another aspect of the present invention is to provide an ingredient mix comprising:
i) microparticulated whey protein material having a denaturation degree within the range of 5-80%;
ii) tri-sodium citrate;
iii) milk solid non-fat other than protein; and
iv) optionally, water;
   wherein the weight ratio between the calcium chelating agent and the microparticulated whey protein material is within the range of 1:10 to 1:1 and wherein the weight ratio between the calcium chelating agent and the milk solid non-fat other than protein is within the range of 1:89 to 1:9.

### BRIEF DESCRIPTION OF THE FIGURES

FIG. 1 shows an example of the particle size distribution of a microparticulated whey protein used in the present invention, and

FIG. 2 shows another example of the particle size distribution of a microparticulated whey protein used in the present invention.

The present invention will now be described in more detail in the following.

### DETAILED DESCRIPTION OF THE INVENTION

### Definitions

Prior to discussing the present invention in further detail, the following terms and conventions will first be defined.

In the context of the present invention, the term “weight ratio” relates to the ratio between the weights of the mentioned components. For example, a mixture comprising 2 g calcium chelating agent and 6 g microparticulated whey protein material would have a ratio by weight of calcium chelating agent and microparticulated whey protein material of 2:6 which is equal to 1:3 or 0.333 (that is: 1 divided with 3). Similarly, a mixture comprising 2 g calcium chelating agent and 4 g microparticulated whey protein would have a ratio by weight of calcium chelating agent and microparticulated whey protein of 2:4 which is equal to 1:2 or 0.5 (that is: 1 divided with 2).

In the context of the present invention, mentioned percentages are weight/weight (w/w) percentages unless otherwise stated.

The term “and/or” used in the context of the “X and/or Y” should be interpreted as “X”, or “Y”, or “X and Y”.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 1 to 8, form 3 to 7, from 4 to 9, from 3.6 to 4.6, from 3.5 to 9.9, and so forth.

All references to singular characteristics or limitations of the present invention shall include the corresponding plural characteristic or limitation, and vice versa, unless otherwise specified or clearly implied to the contrary by the context in which the reference is made.

Unless defined otherwise, all technical and scientific terms used herein have the same meaning as commonly understood by one of ordinary skill in the art (e.g. in frozen confection products manufacture). Definitions and descriptions of various terms and terms and techniques used in frozen confectionery products manufactured are found in Ice Cream, 6^{th} edition, Robert T Marshall, H. Douglas Goff and Richard W Hartel (2003), Kluwer Academic/Plenum Publishers.

In the context of the present invention, the term “frozen confectionery product” includes in particular ice cream, sorbet, sherbet, water ice, frozen yoghurt, frozen dairy, soft ice, mellorine, frozen custard, non-dairy frozen confection, milk ice, ice lolly, slush, gelato, frozen jelly, frozen beverages, and frozen desserts. Furthermore, frozen confectionaries include various product formats such as bulk products, novelties, i.e., bar and stick items, hard pack and soft serve, molded, decorated items and slices, desserts, miniatures, cups, cones and various combinations thereof. A frozen confectionery product may also contain optional ingredients such as fruit, nuts, chocolate, etc.

Additionally, the term “frozen confectionery product” it is to be understood to cover food products where the product may be stored at ambient temperature (e.g. room temperature) and then subsequently frozen, e.g. at home by the consumer or at a point of selling just before consumption. Thus, the freezing step according to the process of the invention may e.g. be performed by the end-user. It is of course also to be understood that the products may be in a frozen state when delivered to the store or sold in the store in a frozen state.

One object of the present invention is to provide a low-protein frozen confectionery product resembling a corresponding frozen confectionery product with a normal protein content in terms of body, texture, and resistance to melting. The low-protein frozen confectionery product according to the present invention has a protein content within the range of 0.050-1.25% w/w and an edible fat content of at least 5% w/w. Furthermore, it is an object of the present invention to provide a method for producing such a frozen confectionery product. Unless otherwise stated, in the present context, the percentage weight/weight (% w/w) refers to the base composition of the frozen confectionery product.

The particular frozen confectionery product of the present invention is a food product which is consumed in its frozen state, and comprises the following ingredients: Fat (may be of both of animal and/or vegetable origin), MSNF (Milk Solids Non-Fat; i.e. protein, lactose, minerals, salts, and/or vitamins). The frozen confectionery product typically also comprises a sweetening agent (e.g. sugars), and an emulsifying agent.

In a preferred embodiment, the frozen confectionery product is an aerated frozen confectionery product.

Regardless of its taste, the quality of a frozen confectionery product is evaluated by its body, texture, and resistance to melting. The term “body” refers to the whole mass of the frozen confectionery product (its firmness/resistance), while the term “texture” refers to the fine particles of the frozen confectionery product.

The protein content particularly affects the body of the frozen confectionery product. Casein and albumin are found as calcium and magnesium caseinates and albuminates in the milk. As such, they swell by imbibing water. With too little protein the body has little resistance, and with too much protein its hydration produces a very soggy, heavy frozen confectionery product.

Surprisingly, the inventors have found that very low concentrations of protein can be used in the base composition when in combination with a calcium chelating agent.

One aspect of the present invention relates to a low-protein frozen confectionery product having a protein content within the range of 0.05 to 1.25% w/w and an edible fat content of at least 5% w/w, said frozen confectionery product comprising:
i. an ingredient mix comprising:
   1. a microparticulated whey protein material having a denaturation degree within the range of 5-80%, and
   2. citrate calcium chelating agent;
ii. one or more edible fat source;
iv. one or more emulsifying agent, and;
v. water.

Another aspect of the present invention relates to a method for producing a low-protein frozen confectionery product having a protein content within the range of 0.050-1.25% w/w and an edible fat content of at least 5% w/w, said method comprising the steps of:
a) providing a base composition comprising:
   i. an ingredient mix comprising:
      1. a microparticulated whey protein material having a denaturation degree within the range of 5-80%, and
      2. calcium chelating agent
   ii. an edible fat source
   iii. an emulsifying agent, and
   iv. water;
b) mixing said base composition to obtain an emulsified mixture, and;
c) freezing said emulsified mixture to obtain the low-protein frozen confectionery product.

In the context of the present invention, the term “calcium chelating agent” refers to a chelating agent which binds to the metal ion, calcium. The calcium chelating agent may be a salt (ions) or a or molecules. According to IUPAC, a chelating agent is the formation or presence of two or more separate coordinate bonds between a polydentate (multiple bonded) ligands and a single central atom. Usually, these ligands are organic compound, which may be termed “chelating agents”, chelants, chelators, or sequestering agents. Thus, a chelating agent are chemicals which that form soluble, complex molecules with certain metal ions, and inactivating the ions so that they cannot normally react with other elements or ions to produce precipitates or scale. A calcium chelating agent is a chemical which form a complex molecule with the calcium ion. Hereby, the calcium ion are inactivated such that it cannot react with other elements or ions.

The calcium chelating agent according to the present invention is an edible calcium chelating agent.

In an embodiment of the invention, the calcium chelating agent is any salt of citrate or disodium ethylenediaminetetraacetate dehydrate (disodium EDTA). Preferably, the calcium chelating agent is mono-sodium citrate, di-sodium citrate or tri-sodium citrate.

In a preferred embodiment the calcium chelating agent is tri-sodium citrate.

The calcium chelating agent may for example be the lithium, sodium or potassium salt of citrate or calcium disodium EDTA. Preferably the calcium chelating agent is tri-sodium citrate.

In one embodiment of the present invention, the base composition comprises calcium chelating agent, preferably tri-sodium citrate, in an amount of at least 0.01% w/w, such as within the range of 0.01-25% w/w, e.g. within the range of 0.02-20% w/w, such as within the range of 0.03-19% w/w, e.g. within the range of 0.035-18% w/w such as within the range of 0.045-17% w/w, e.g. within the range of 0.09-10% w/w, such as within the range of 0.10-5% w/w, e.g. within the range of 0.135-4% w/w, such as within the range of 0.180-3% w/w, e.g. within the range of 0.225-2% w/w, such as within the range of 0.270-1% w/w, e.g. within the range of 0.315-0.950% w/w, such as within the range of 0.360-0.900% w/w, e.g. within the range of 0.4-0.8% w/w, such as within the range of 0.45-0.75% w/w, e.g. within the range of 0.5-0.7% w/w. Preferably, the base composition comprises an amount of a calcium chelating agent, preferably tri-sodium citrate, within the range of 0.045-0.18% w/w. The calcium chelating agent, preferably tri-sodium citrate salt, may be used in different hydrated forms.

In another embodiment of the present invention, the weight ratio between the calcium chelating agent and the microparticulated whey protein material is within the range of 1:10 to 1:1, such as within the range of 1:9 to 1:2, e.g. within the range of 1:9 to 1:3, such as within the range of 1:8 to 1:3, e.g. within the range of 1:7 to 1:4, such as within the range of 1:6 to 1:5.

In yet another embodiment of the present invention, the ingredient mix further comprises a milk solid non-fat (MSNF) other than protein.

In another embodiment of the present invention, the weight ratio between the calcium chelating agent and the milk solid non-fat (MSNF) other than protein is within the range of 1:89 to 1:9, such as within the range of 1:80 to 1:10, e.g. within the range of 1:70 to 1:15, such as within the range of 1:60 to 1:20, e.g. within the range of 1:50 to 1:25, such as within the range of 1:40 to 1:30.

### Fat

The edible fat according to the present invention may be both of animal and (or vegetable origin. The animal fat preferably comes from milk fat, butter fat or cream.

Fat provides flavour, body, and texture to the frozen confectionery product. The type and content of fat in the frozen confectionery product are used to classify individual products according to certain regulations, but these regulations varies from country to country.

The types of vegetable fat most widely used are coconut oil, palm oil, and palm kernel oil, or a combination thereof.

In a further embodiment, the frozen confectionery product has a fat content within the range of 5-25% (w/w) of the frozen confectionery product, e.g. within the range of 6-20% (w/w), preferably within the range of 7-15% (w/w) of the frozen confectionery product, e.g. within the range of 8-14% (w/w), more preferably within the range of 9-13% (w/w) of the frozen confectionery product.

In another embodiment of the present invention, the fat content of the frozen confectionery product is within the range of 5-24% w/w, such as within the range of 6-23% w/w, e.g. 7-21% w/w, such as within the range of 8-20% w/w, e.g. 9-19% w/w, such as within the range of 10-18% w/w, e.g. 11-17% w/w, such as within the range of 12-16% w/w, e.g. 13-15% w/w.

The amount of fat may vary depending on the type of product. Edible fat components include milk fat, butter fat, cream, and vegetable fats. Vegetable fats suitable for use herein include, but is not limited to, coconut oil, soy oil, corn oil, olive oil, safflower oil, high oleic safflower oil, algal oil, MCT oil (medium chain triglycerides), sunflower oil, high oleic sunflower oil, palm and palm kernel oils, palm olein, canola oil, marine oils, cottonseed oils, and combinations thereof. Preferably, vegetable fats such as cocoa butter, rapeseed oil, sunflower oil or palm oil, preferably not hydrogenated, are used.

### Non-Fat Milk Solids

Non-fat milk solids include proteins (whey and casein), lactose, vitamins, and minerals. The proteins contribute to the structure of the frozen confectionery product and to the incorporation of air during processing. Lactose contributes to the sweetness and minerals are derived from the milk or cream used in the production.

In one embodiment of the present invention, the protein content of the frozen confectionery product is within the range of 0.050-1.25% w/w, such as within the range of 0.10-1.22% w/w, e.g. 0.2-1.20% w/w, such as within the range of 0.5-1.18% w/w, e.g. in the range of 0.6-1.15% w/w, e.g. 0.65-1.10% w/w, such as within the range of 0.7-1.05% w/w, e.g. 0.75-1.00% w/w, such as within the range of 0.8-0.95% w/w.

In an embodiment of the invention, the protein content in the confectionery product is in the range 0.50-1.25% w/w.

In another embodiment of the present invention, the protein content of the frozen confectionery product is within the range of 0.55-0.99% w/w, such as within the range of 0.60-0.95% w/w, e.g. 0.65-0.90% w/w, such as within the range of 0.70-0.89% w/w, e.g. 0.70-0.85% w/w, such as within the range of 0.75-0.80% w/w.

In yet another embodiment of the present invention, the protein content of the frozen confectionery product is within the range of 0.70-1.10% w/w and the fat content of the frozen confectionery product is within the range of 5-18% w/w. Preferably, the protein content of the frozen confectionery product is within the range of 0.80-1.10% w/w and the fat content of the frozen confectionery product is within the range of 7-15% w/w.

In yet another embodiment of the present invention, the protein content of the frozen confectionery product is within the range of 0.60-0.99% w/w, e.g. 0.65-0.95% w/w, and the fat content of the frozen confectionery product is within the range of 5-19% w/w, e.g. 9-15% w/w. More preferably, the protein content of the frozen confectionery product is within the range of 0.75-0.95% w/w and the fat content of the frozen confectionery product is within the range of 8-15% w/w.

Whey proteins are used as functional ingredients in many food products not only for their nutritional properties, but also for their functional and technological properties. “Whey protein” is the name of a collection of globular proteins that can be isolated from liquid whey. It is typically a mixture of beta-lactoglobulin (˜65%), alpha-lactalbumin (˜25%), and serum albumin (˜8%), which are soluble in their native forms, independent of pH. The functional properties of whey proteins may be referred to as:

(a) hydration properties that have an important effect on wettability, swelling, adhesion, dispersibility, solubility, viscosity, water absorption, and water holding;
(b) interfacial properties including emulsification and foaming characteristics;
(c) aggregation and gelation properties which are related to protein-protein interactions.

These functionalities can be affected by either heat treatment or pressure treatment.

In one embodiment of the present invention, a considerable amount of the protein in the frozen confectionery product is microparticulated whey protein material, such as at least 50% of the protein in the frozen confectionery product is microparticulated whey protein material, e.g. 50-100%, such as 60-99%, e.g. 65-98%, such as 70-97%, e.g. 75-96%, such as 80-95% of the protein in the frozen confectionery product is microparticulated whey protein material.

All types of whey protein materials are considered to be potential sources of microparticulated whey protein for use in the present invention. Thus, for example, suitable whey protein materials include whey obtained from conventional cheese making processes, such as “acid whey” or “sweet whey”, whey protein isolates, whey protein concentrates, whey protein fractions, and the like. Such materials should of course be subjected to a microparticulation process. Thus, whey protein materials which contain microparticulated whey proteins may be provided in or combined into an aqueous mixture, generally a slurry of whey protein solids. The microparticulated whey protein may be used as a whey powder.

In the context of the present invention, the term “microparticulated whey” refers to a whey protein product, e.g. whey protein concentrate, which has subjected to a microparticulation process such that protein aggregates. Microparticulation is a thermal or mechanical treatment to denature whey proteins and create ideal particles similar to the size of fat globules in milk, preferably 20-80 μm. For example microparticulation is made by high heat treatment combined with controlled shear force.

Microparticulated whey protein (MWP) is manufactured from whey protein concentrate in a process that primarily involves simultaneous heating and shearing (EP0250623). Alternative processes may be utilized instead, such as extrusion cooking at acid pH (Queguiner, Dumay, Saloucavalier, & Cheftel, 1992) or dynamic high pressure shearing, i.e., microfluidization (Dissanayake & Vasiljevic, 2009). The result is whey protein aggregates with particle sizes that usually range between 0.1 and 10 μm (Spiegel & Huss, 2002). Whether these microparticles act as active or inert fillers in the frozen confectionery product network has not been elucidated.

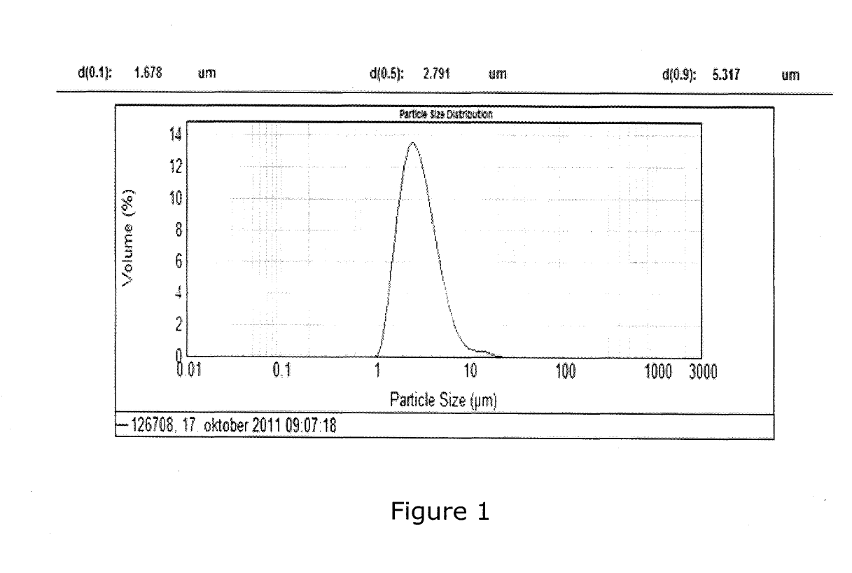

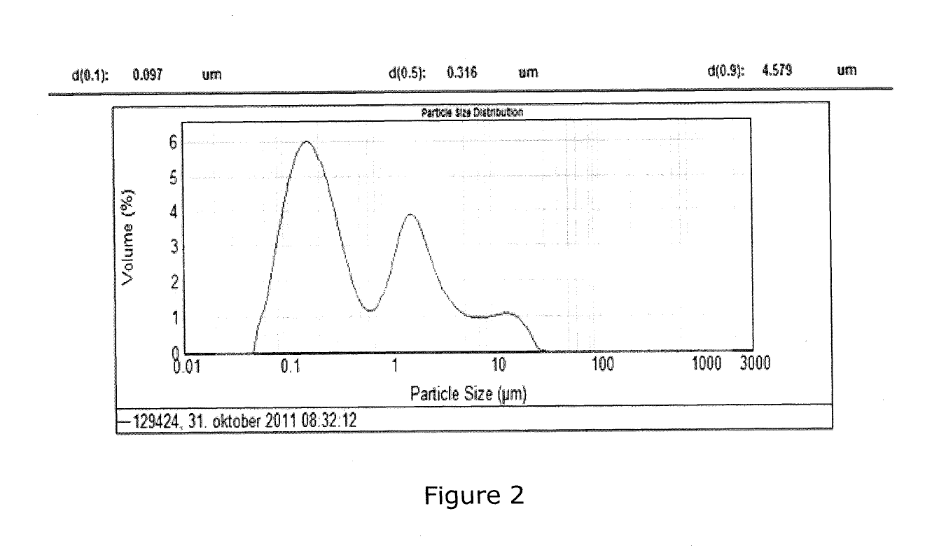

In one embodiment of the present invention, at least 80% of the microparticulated whey protein material has a particle size distribution within the range of 0.001-10 μm, such as at least 85%, e.g. 90%, such as at least 95% of the microparticulated whey protein material has a particle size distribution within the rage of 0.001-10 μm. An example of the particle size distribution of a microparticulated whey protein used in the present invention can be seen in FIGS. 1-2. In FIG. 1, the percentage of the particles being below 1 μm is 0%, the percentage below 5 μm is 87.83%, and the percentage below 10 μm is 98.68%. In FIG. 2, the percentage of particles being below 1 μm is 63.45%, the percentage below 5 μm is 90.61%, and the percentage below 10 μm is 94.97%.

In another embodiment of the present invention, the particle size of the microparticulated whey protein material, as indicated by D(v,0.5), is at most 5 μm, such as within the range of 1-4.5 μm, e.g. about 4 μm, such as within the range of 1.2-3.8 μm, e.g. about 3.6 μm, such as within the range of 1.4-3.4 μm, e.g. about 3.2 μm, such as within the range of 1.6-3.0 μm, e.g. about 2.8 μm, such as within the range of 1.8-2.6 μm, e.g. about 2.4 μm. The volume median diameter D(v,0.5) is the diameter where 50% of the distribution is above and 50% is below. The particle size distribution is measured by static light scattering (Malvern Mastersizer Micro Particle Sizer, Malvern Instruments Ltd., Worcestershire, UK) (Shown under Example 2).

In still another embodiment of the present invention, the particle size of the microparticulated whey protein material, as indicated by D(v, 0.1), is at most 3 μm, such as within the range of 0.01-2.5 μm, e.g. about 2 μm, such as within the range of 0.1-1.8 μm, e.g. about 1.7 μm, such as within the range of 0.2-1.6 μm, e.g. about 1.5 μm, such as within the range of 0.3-1.4 μm, e.g. about 1.3 μm, such as within the range of 0.4-1.3 μm, e.g. about 1.2 μm. D(v,0.1) means that 10% of the volume distribution is below this value.

In yet another embodiment of the present invention, the particle size of the microparticulated whey protein material, as indicated by D(v, 0.9), is at most 15 μm, such as within the range of 1-14.5 μm, e.g. about 13 μm, such as within the range of 2-12.5 μm, e.g. about 11 μm, such as within the range of 3-10.5 μm, e.g. about 9 μm, such as within the range of 3-8.5 μm, e.g. about 7 μm, such as within the range of 4-6.5 μm, e.g. about 5 μm. D(v,0.9) means that 90% of the volume distribution is below this value.

Denaturation of whey protein, such as microparticulated whey protein, results from a complex mechanism dominated by the denaturation of α-lactoglobulin which has been explained by Simmons et al., (2007) and Schokker et al. (2000), by a two-step process. The first step is endothermic; which consists of protein unfolding and changes in the equilibrium between protein dimers and native and non-native monomers, associated with reversible or irreversible intramolecular rearrangements (e.g. disruption of hydrogen bonds). The second step corresponds to aggregation, resulting mainly from an intermolecular -SH to S-S exchange and, to a lesser extent, from non-covalent interactions. Aggregation starts with the formation of non-native dimers and oligomers which rapidly grow as a function of chemical environment and temperature, mainly by incorporation of monomers and smaller aggregates. The denaturation degree of the proteins present in the MWP powders was analyzed by size exclusion high performance liquid chromatography (SE-HPLC) (Shown under Example 2).

In the context of the present invention, the microparticulated whey protein material has a denaturation degree within the range of 5-80%. In an embodiment of the invention, the microparticulated whey protein material has a denaturation degree within the range of 10-80%, such as 20-80%. e.g. 40-80%, e.g. within the range of 45-75%, such as within the range of 50-70%, e.g. within the range of 55-70%, such as within the range of 60-65%.

In an embodiment of the invention, the microparticulated whey protein material has a denaturation degree within the range of 40-80%.

In another embodiment, the frozen confectionery product according to the invention comprises a milk solid non-fat content in the range of 5-20% (w/w), preferably in the range of 5-15% (w/w), more preferably in the range of 5-10% (w/w).

“Whey” or “liquid whey” is a collective term referring to the serum or watery part of milk that remains after removal or coagulation or precipitation of casein molecules from milk (e.g. manufacture of cheese). The milk may be from one or more domesticated ruminants, such as cows, sheep, goats, yaks, water buffaloes, horses, or camels.

In the present context, the term “acid whey” (also known as sour whey) relates to whey, which is obtained during the production of acid type cheese such as cottage cheese and quark, or from the production of casein/caseinates. The pH value of acid whey can range between 3.8 and 4.6.

“Sweet whey” relates to whey which is obtained during the production of rennet type hard cheese like Cheddar or Swiss cheese. The pH value of sweet whey can range between 5.2 and 6.7.

The term “whey powder” relates to the product obtained by drying the liquid whey.

In the present context, the expressions “whey Protein Concentrate (WPC)” relates to the dry portion of liquid whey obtained by the removal of sufficient non-protein constituents from whey so that the dry product contains not less than 25% protein.

A low-protein diet is any diet in which the protein intake is reduced. Anyone diagnosed with kidney or liver disease may be prescribed a low-protein diet.

Protein is necessary for a healthy body. When protein is metabolized by the liver and digested, urea is produced as a waste product. If the liver is diseased, then food metabolism is compromised. If the kidneys, which are responsible for excretion of urea, are not functioning properly (renal failure), or if high levels of protein are continually present in the diet, urea builds up in the bloodstream causing loss of appetite and fatigue. A low-protein diet will reduce the workload on these organs.

Decreasing protein in the diet may also mean a reduction of calories. To compensate so as to maintain a healthy weight, one should increase calories by substituting or adding certain ingredients rich in calories, such as sugar and/or fat. Hence, there is a need for food products low on protein and high on e.g. sugar and/or fat. Such food products should preferably resemble the normal food products, especially in regard to the organoleptic properties.

Phenylalanine is an essential amino acid for humans and animals. In the organism, this amino acid is used as a component in the synthesis of proteins including structural proteins, enzymes, and hormones. Patients suffering from an impaired function of phenylalanine hydroxylase (PAH) accumulate phenylalanine in the body, including the blood (hyperphenylalaninemia). Furthermore, the patients excrete phenylpyruvate in the urine, i.e. phenylketonuria (PKU), the common clinical designation for the metabolic disorder caused by the impaired PAH function. If PKU is left untreated, the condition eventually results in mental retardation.

The immediate treatment of new-born PKU children includes a phenylalanine-restricted diet preventing the mental retardation. PKU patients must follow an accurate phenylalanine-restricted diet for lifetime in order to avoid that the brain function is affected.

When children in the Western world become teenagers, they begin to doubt as to the need for keeping their accurate diet. The doubt is primarily driven by a desire to live a normal life like healthy teenagers eating food with a high content of phenylalanine. Accordingly, their phenylalanine-reduced diet may be compromised which is often accompanied by impaired brain function.

In order to obtain the nutrients that their bodies need, people with PKU must consume synthetic phenylalanine-free protein drinks throughout the day. The formula and special foods are very expensive and often unpalatable. Hence, there is a need for low-cost food products that can be consumed by people with PKU, especially children that just want to blend in. Such food products should preferably resemble the normal food products.

In one embodiment of the present invention, the microparticulated whey protein material is caseinoglycomacropeptide (CGMP).

In the present context, the term “caseinoglycomacropeptide” is abbreviated as “CGMP”. Caseinoglycomacropeptide may also be termed caseino-glycomacropeptide or casein-glycomacropeptide. In the present context, CGMP refers to caseinoglycomacropeptide and/or its subcomponents and/or its bioactive hydrolytic products. Commercially available CGMP products include LACPRODAN CGMP-10 (CGMP-10) and LACPRODAN CGMP-20 (CGMP-20) from Arla Foods Ingredients amba. CGMP-10 and CGMP-20 are rich sources of protein-bound sialic acid. CGMP-20 comprises an extremely low level of phenylalanine, thus making CGMP-20 a useful protein source for people suffering from phenylketonuria (PKU). Caseinoglycomacropeptides (CGMPs) may be used in any suitable form, including salts of calcium, sodium or potassium, for example.

CGMP can be obtained by an ion-exchange treatment of a liquid lactic raw material containing CGMP. Suitable starting materials of lactic origin may include for example: a) the product of the hydrolysis with rennet of a native casein obtained by acidic precipitation of skimmed milk with a mineral acid or acidifying ferments, optionally with addition of calcium ions; b) the hydrolysis product of a caseinate with rennet; c) a sweet whey obtained after separation of casein coagulated with rennet; d) a sweet whey or such a whey demineralized, for example, by electrodialysis and/or ion exchange and/or reverse osmosis; e) a concentrate of sweet whey; f) a concentrate of whey proteins obtained by ultrafiltration and diafiltration of sweet whey; g) mother liquors of the crystallization of lactose from a sweet whey; h) a permeate of ultrafiltration of a sweet whey. One method used to prepare CGMP is described in WO 98/53702 and consists in the decationization of the liquid raw material, such that the pH has a value of 1 to 4.5, bringing the said liquid into contact with a weak anionic resin of hydrophobic matrix, predominantly in alkaline form up to a stabilized pH, then separation of the resin and the liquid product which is recovered, and desorption of CGMP from the resin.

In another embodiment, the frozen confectionery product according to the invention comprises a milk solid non-fat content in the range of 5-20% (w/w), preferably in the range of 5-15% (w/w), more preferably in the range of 5-10% (w/w). Again, the amount of milk solid non-fat (MSNF) may vary depending on the type of product.

In one embodiment, the frozen confectionery product according to the invention comprises a dietary supplement ingredient intended to supplement the diet. Non-limiting examples of such a “dietary supplement ingredient” include vitamins, minerals, herbs or other botanicals, amino acids, and substances such as enzymes, organ tissues, glandulars, and metabolites.

Vitamins and similar other ingredients suitable for use herein include but is not limited to vitamin A, vitamin D, vitamin E, vitamin K, thiamine, riboflavin, pyridoxine, vitamin B12, niacin, folic acid, pantothenic acid, biotin, vitamin C, choline, inositol, salts and derivatives thereof, and combinations thereof.

Minerals suitable for use herein include but are not limited to calcium, phosphorus, magnesium, iron, zinc, manganese, copper, chromium, iodine, sodium, potassium, chloride, and combinations thereof.

### Sweetening Agents

In an embodiment of the invention, a sweetening agent is comprised in the low protein frozen confectionery product and thus included in the base composition and the method for producing the low-protein confectionery product.

A sweetening agent, for example sugar, is added to provide sweetness and improves texture. A combination of sweetening agents (sucrose, glucose, fructose etc.) is normally used to obtain the desired sweetness of the final product. Sugars as the sweetening agent control the amount of frozen water in frozen confectionery products and therefore the softness of the final product. Frozen confectionery products preferably contains contain some added sweetening agent. Non-sugar sweetening agents may also be used.

In a further embodiment, the sweetening agent is selected from:
I. a natural sweetening agent such as Momordica Grosvenorii (Mogrosides IV or V), Rooibos extracts, Honeybush extracts, Stevia, Rebaudioside A, thaumatin, Brazzein, Glycyrrhyzic acid and its salts, Curculin, Monellin, Phylloducin, Rubusosides, Mabinlin, dulcoside A, dulcoside B, siamenoside, monatin and its salts (monatin SS, RR, RS, SR), thaumatin, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, erythritol, and/or other natural polyols such as maltitol, mannitol, lactitol, sorbitol, inositol, Isomalt, xylitol, glycerol, propylene glycol, threitol, galactitol, reduced isomalto-oligosaccharides, palatinose, reduced xylo-oligosaccharides, reduced gentio-oligosaccharides, reduced maltose syrup, reduced glucose syrup, a monosaccharide, a disaccharide, an oligosaccharide, or a mixture thereof;
II. an artificial sweetening agent such as Aspartame, Cyclamate, Sucralose, Acesulfame K, neotame, Saccharin, Neohesperidin dihydrochalcone, or mixtures thereof;
III. a sugar, such as sucrose, glucose, galactose, dextrose, fructose, or mixtures thereof;
IV. a fruit source, such as a fruit juice, a fruit concentrate or a fruit puréor
V. a combination of any of the sweeteners listed in I), II), iii), and IV).

In yet an embodiment, the frozen confectionery product comprises at least one sugar different from sucrose, wherein said sugar different from sucrose is a monosaccharide and/or a disaccharide and/or an oligosaccharide. In yet an embodiment, the monosaccharide is glucose, galactose, dextrose, fructose, or any combination thereof. In yet another embodiment, the disaccharide is maltose, lactose, or any combination thereof.

In one embodiment, the invention relates to an frozen confectionery product wherein the content of the sweetening agent is within the range of 10-30% (w/w) by weight of the frozen confectionery product, preferably in the range of 15-20% (w/w) by weight of the frozen confectionery product.

### Flavourings and Colourings

Flavourings and colourings may be added to the frozen confectionery product to enhance the appearance and taste of the product. Preferably, most of these flavourings and colourings are natural.

### Emulsifiers and Stabilisers

Emulsifiers help bind all the ingredients during the manufacturing process and improve the whipping quality during mixing.

Stabilisers may be added to the frozen confectionery product to improve air incorporation. Furthermore, stabilizers may have a positive influence on the body and texture of the frozen confectionery product; contributing to the creaminess and melting properties of the finished product.

In yet an embodiment, the frozen confectionery product comprises a stabilizer and/or emulsifier within the range of 0.01-3% (w/w). In an additional embodiment, the content of the emulsifier component is within the range of 0.1 to 0.5% (w/w) of the frozen confectionery product.

Suitable emulsifiers to be used are monoglycerides, diglycerides, polysorbate, or polyol esters of fatty acids such as propylene glycol monoester of fatty acids, as well as natural emulsifiers such as egg yolk, butter milk, raw acacia gum, rice bran extract, or mixtures thereof.

Suitable stabilizers which can be used in the present invention include locust bean gum, guar gum, alginates, cellulose, xanthan gum, carboxymethyl cellulose, microcrystalline cellulose, alginates, carrageenans, pectins, and mixtures thereof.

### Other Ingredients

Other ingredients such as fruit or chocolate (depending on the flavour required) may be added to provide additional flavour and enhance appearance.

The individual base components such as fat globules, proteins, carbohydrates, salts, and water play important roles during the freezing process. In the freezer, the base composition is converted into a viscous foam through the incorporation of air by agitation. At the same time, water present in the mix is converted into ice crystals by the cold temperature. The air cells are stabilized by the adhesion of stabilizers (e.g. hydrophilic colloids) to the air bubble surface. During the initial stages of whipping, air bubbles are stabilized primarily by milk proteins with little involvement of fat. As the agitation continues, fat globules become more and more crystalline, and some of them coalesce and form a network that supports the foam. In the frozen state, only about 50% of the water is frozen in the ice cream. Therefore, a frozen confectionery product (as well as ice cream) is a four-phase system of fat globules, air bubbles, ice crystals, and a concentrated serum phase containing the soluble components (i.e. water+water soluble components).

Ice cream and related products are generally aerated and characterized as frozen foams. Increasing ice cream volume is one role of stabilizers, brought about through increasing viscosity and maintaining the air bubbles. The amount of air in frozen confectionery product is important because it influences quality and profits. Further, the air cell structure has proven to be one of the main factors influencing melting rate, shape retention during meltdown, and the rheological properties in the molten state, which are correlated to creaminess. Smaller air cells improve the product quality regarding these three indicators. In the present context, the term “overrun” refers to the % increase in volume of the frozen confectionery product greater than the amount of base composition used to produce that frozen confectionery product. Basically, the term “overrun” applies to the amount of air the frozen confectionery product contains. The percentage of overrun ranges from 0 (no air) to 200, a theoretical figure that would be all air. The legal limit for overrun in ice cream in the US is 100 percent (100%), which would amount to half air.

Any treatment of the ingredients of the frozen confectionery product (as with ice cream) or of the base composition itself that increases the viscosity affects the body and texture of the ice cream. Pasteurization, homogenization, and aging all affect the viscosity. Though the texture of the frozen confectionery product, like the body, is affected by the ingredients used and their proportions, it is also affected to a greater extent than the body by the freezing process. The texture of the frozen confectionery product depends largely on the size of the crystals and the amount of air incorporated during freezing.

In one embodiment of the present invention, the low-protein frozen confectionery product is aerated and has an overrun within the range of 10-190%, e.g. within the range of 20-170%, such as within the range of 30-150%, e.g. within the range of 40-130%, such as within the range of 50-120%, e.g. within the range of 60-110%.

The frozen confectionery product of the present invention is chilled (aged), aerated, and partially frozen in freezers. The two types of freezers commonly employed in ice production are batch and continuous. Both types have a heat-exchange cylinder and a turning dasher with scraper blades.

A batch freezer chills a given amount of product, aerates at atmospheric pressure, and continues chilling until 30-35% of the water is frozen. A continuous freezer incorporates air under 3.5-5 atmospheric (atm) pressure and chills the product until 35-55% of the water is frozen. These methods can be readily used in the present invention. Hence, the aging time of the present invention may vary depending on the specific base composition and/or equipment used.

The freezing point of a frozen confectionery product is critical in manufacturing an acceptable product. The frozen confectionery product must have a freezing point high enough to allow adequate and small ice crystal formation. If the freezing point is too low, a lower percentage of water is frozen, which increases the effects of heat shock when the temperature fluctuates during storage. The freezing point of any solution depends on the purity of that solution, and increasing the amount of solutes will decrease the freezing point.

For a frozen confectionery product, the term “freezing” involves crystallizing a portion of water in the base composition and incorporating air into the base composition. Freezing lowers the base composition temperature from “refrigerated or aging temperature” (4-6° C.) to the freezing point. The temperature of the base composition that enters the freezer drops very rapidly as the sensible heat is removed. As the freezing point is reached, liquid water changes to ice crystals. This increases the concentrations of sugars and other solutes present in the base composition. The increased concentrations will depress the freezing point further, and therefore the temperature must be lowered to form more ice crystals. When the concentrations become very high, the ice crystallization process will stop, leaving a portion of water unfrozen (10-15%), even after a long period in the hardening room.

Yet another aspect of the present invention relates to an ingredient mix comprising:
1. Microparticulated whey protein material having a denaturation degree within the range of 5-80%, preferably 40-80%;
2. calcium chelating agent, such as calcium trisodium citrate;
3. milk solid non-fat (MSNF) other than protein; and
4. Optionally, water;
   wherein the weight ratio between the calcium chelating agent and the microparticulated whey protein material is within the range of 1:10 to 1:1 and wherein the weight ratio between the calcium chelating agent and the milk solid non-fat (MSNF) other than protein is within the range of 1:89 to 1:9.

In one embodiment of the present invention, the ingredient mix comprises an amount of calcium chelating agent of at least 0.1% w/w, such as within the range of 0.2-20% w/w, e.g. within the range of 0.3-19% w/w, such as within the range of 0.5-18% w/w, e.g. within the range of 0.75-10% w/w, such as within the range of 1-9% w/w, e.g. within the range of 1.5-8% w/w, such as within the range of 2-7% w/w, e.g. within the range of 2.5-6.5% w/w, such as within the range of 3-6% w/w, e.g. within the range of 3.5-5.5% w/w, such as within the range of 3.75-5% w/w, e.g. within the range of 4-4.75% w/w. Preferably, the ingredient mix comprises an amount of calcium chelating agent, such as tri-sodium citrate, within the range of 0.5-2.5% w/w. The calcium chelating agent, such as tri-sodium citrate salt, may be used in different hydrated forms.

In yet another embodiment of the present invention, the ingredient mix comprises an amount of calcium chelating agent of at least 1% w/w, preferably within the range of 2-3% w/w.

The calcium chelating agent is preferably any salt of citrate, mono-sodium citrate, di-sodium citrate, tri-sodium citrate or disodium EDTA.

In another embodiment of the present invention, the weight ratio between the calcium chelating agent and the MSNF other than protein is within the range of 1:89 to 1:9, such as within the range of 1:80 to 1:10, e.g. within the range of 1:70 to 1:15, such as within the range of 1:60 to 1:20, e.g. within the range of 1:50 to 1:25, such as within the range of 1:40 to 1:30.

In still another embodiment of the present invention, the weight ratio between the calcium sodium citrate and the microparticulated whey protein material is within the range of 1:10 to 1:1, such as within the range of 1:9 to 1:2, e.g. within the range of 1:9 to 1:3, such as within the range of 1:8 to 1:3, e.g. within the range of 1:7 to 1:4, such as within the range of 1:6 to 1:5.

In one embodiment of the present invention, at least 80% of the microparticulated whey protein material in the ingredient mix has a particle size distribution within the rage of 0.001-10 μm, such as at least 85%, e.g. 90%, such as at least 95% of the microparticulated whey protein material has a particle size distribution within the rage of 0.001-10 μm.

In another embodiment of the present invention, the particle size of the microparticulated whey protein material in the ingredient mix, as indicated by D(v,0.5), is at most 5 μm, such as within the range of 1-4.5 μm, e.g. about 4 μm, such as within the range of 1.2-3.8 μm, e.g. about 3.6 μm, such as within the range of 1.4-3.4 μm, e.g. about 3.2 μm, such as within the range of 1.6-3.0 μm, e.g. about 2.8 μm, such as within the range of 1.8-2.6 μm, e.g. about 2.4 μm.

The volume median diameter D(v,0.5) is the diameter where 50% of the distribution is above and 50% is below.

In still another embodiment of the present invention, the particle size of the microparticulated whey protein material in the ingredient mix, as indicated by D(v, 0.1), is at most 3 μm, such as within the range of 0.01-2.5 μm, e.g. about 2 μm, such as within the range of 0.1-1.8 μm, e.g. about 1.7 μm, such as within the range of 0.2-1.6 μm, e.g. about 1.5 μm, such as within the range of 0.3-1.4 μm, e.g. about 1.3 μm, such as within the range of 0.4-1.3 μm, e.g. about 1.2 μm. D(v,0.1) means that 10% of the volume distribution is below this value.

In yet another embodiment of the present invention, the particle size of the microparticulated whey protein material in the ingredient mix, as indicated by D(v, 0.9), is at most 15 μm, such as within the range of 1-14.5 μm, e.g. about 13 μm, such as within the range of 2-12.5 μm, e.g. about 11 μm, such as within the range of 3-10.5 μm, e.g. about 9 μm, such as within the range of 3-8.5 μm, e.g. about 7 μm, such as within the range of 4-6.5 μm, e.g. about 5 μm. D(v,0.9) means that 90% of the volume distribution is below this value.

In yet another embodiment of the present invention, the ingredient mix further comprises water in an amount of at most 4% w/w, such as within the range of 0.1-4% w/w, e.g. about 0.2% w/w, such as within the range of 0.3-3.9% w/w, e.g. about 0.5% w/w, such as within the range of 0.7-3.5% w/w, e.g. about 0.9% w/w, such as within the range of 1.0-3.0% w/w, e.g. about 1.5% w/w, such as within the range of 2.0-3.0% w/w, e.g. about 2.5% w/w.

Yet another aspect of the present invention relates to an ingredient mix consisting of:
1. Microparticulated whey protein material having a denaturation degree within the range of 5-80%;
2. calcium chelating agent;
3. MSNF other than protein; and
4. Optionally, water;
   wherein the weight ratio between the calcium chelating agent and the microparticulated whey protein material is within the range of 1:10 to 1:1 and wherein the weight ratio between the tri-sodium citrate and the MSNF other than protein is within the range of 1:89 to 1:9.

It should be noted that embodiments and features described in the context of one of the aspects of the present invention also apply to the other aspects of the invention.

All patent and non-patent references cited in the present application are hereby incorporated by reference in their entirety.

The invention will now be described in further details in the following non-limiting examples.

### EXAMPLES

The present invention is further illustrated by the following examples, which are not to be construed in any way as limitations upon the scope thereof. On the contrary, it is to be clearly understood that resort may be had to various other embodiments, modifications, and equivalents thereof which, after reading the description therein, may suggest themselves to those skilled in the art without departing from the spirit of the present invention and/or the scope of the appended claims. Unless otherwise specified, %'s are by weight.

Due to the increased price of frozen confectionery products comprising whey protein, the aim was to reduce the production costs by lowering the content of protein in a frozen confectionery product, and at the same time retaining the organoleptic and/or melting properties. Simply substituting a part of the protein with water was found to be unsatisfactory. Hence, a trial was set up to find an adjuvant with the right properties.

### Example 1

### Preparation of a Frozen Confectionery Product

The table below discloses a general recipe for a frozen confectionery product comprising whey protein and adjuvant:

| Ingredient | % by weight (% w/w) | |
|---|---|---|
| Fat | 5-25% | w/w |
| Whey protein material | 0.050-1.25% | w/w |
| Adjuvant | 0.05-1.25% | w/w |
| MSNF (Milk Solids Non-Fat) other than protein | 2-10% | w/w |
| Sweetening agent | 8-20% | w/w |
| Emulsifier + Stabiliser | 0.01-2.0% | w/w |
| Water | 50-70% | w/w |
| Total input ingredients | 100% | w/w |

The process could be performed as follows:
Mixing. Mixing is done in order to dissolve ingredients properly;
Homogenisation. The purpose is 1) to obtain a uniform and small fat globule size in the emulsion, 2) to obtain a new fat globule membrane combining protein and emulsifier, and 3) to provide the frozen confectionery product with a smoother structure, increased creaminess and a better melting resistance;
Pasteurisation. The purpose is to 1) destroy pathogenic bacteria, and 2) to increase the water binding ability of protein and stabilizers.
Normal pasteurisation methods are:
   Batch pasteurizer; 69° C./30 min.
   Plate heat exchanger; 85-88° C./30-40 sec.
Ageing. Ageing is performed at temperatures around 5° C. for a minimum of hours. The purpose is to 1) hydrate milk proteins and stabilizers, 2) desorb proteins from the fat globule membrane, and 3) crystallize the liquid fat.
Freezing. The purpose is 1) cooling and ice crystal formation, 2) incorporation of air, and 3) partial agglomeration of fat.
Filling/packing.
Hardening. The purpose is to freeze 80-90% of the remaining water, which occurs at −30° C. to −40° C. for 12-24 hours.
Storage.

### Example 2

### Preparation of Whey Protein Material

### Microparticulated Whey Protein

Microparticulation is done in order to reach the desired particle size. E.g. too many small particles will lead to a product with a very watery consistency, combined with a cold taste sensation. It was found that at least 90% of the microparticulated whey protein material should have a particle size distribution within the rage of 0.001-10 μm.

Arla Food Ingredients (Nr. Vium, Videbk, Denmark) carried out the production of microparticulated whey proteins (MWPs). The applied processing method can be varied to obtain protein solutions or spray-dried MWP powders with different final characteristics in terms of particle size and denaturation degree of the whey proteins.

### Particle Size Distribution of Microparticulated Whey Protein

The powders were reconstituted in water (10%, w/v). After 1 h of hydration at room temperature, the particle size distributions of the solutions were measured by static light scattering (Malvern Mastersizer Micro Particle Sizer, Malvern Instruments Ltd., Worcestershire, UK). Particle refractive index 1.52 (real part), 0.1 (imaginary part) and dispersant refractive index 1.33 were used. The data was fitted using the Mie scattering model (residuals <2%). Each sample was measured in triplicate. The percentiles D(v, 0.1), D(v, 0.5) and D(v, 0.9) were extracted and used for further data analysis.

### Denaturation Degree of Microparticulated Whey Protein (MWP)

A denaturation degree of 5-80% of the protein was found to be preferable in order to receive the right structure in the end product. Too high a denaturation degree led to a frozen confectionery with too firm a structure that felt hard and compact and with a slow flavor release.

Too low denaturation affected the particle size in a negative manner, i.e. it was not possible to create proteins with the right particle size.

The denaturation degree of the proteins present in the MWP powders was analyzed by size exclusion high performance liquid chromatography (SE-HPLC). A Waters 600 E Multisolvent Delivery System, a Waters 700 Satellite Wisp Injector, and a Waters H90 Programmable Multiwavelength Detector (Waters, Milford, Mass., USA) were used. The elution buffer was composed of 0.15 M Na₂SO₄, 0.09 M KH₂PO₄ and 0.01 M K₂HPO₄. The flow rate was 0.8 mL min⁻¹ and the temperature 20° C.

Twenty-four hours prior to analysis, MWP solutions were prepared by using a sodium phosphate buffer (0.02 M) to obtain a final protein content of 0.1% (w/v). In addition, standard solutions of a-lactalbumin (Sigma-Aldrich Chemie GmbH, Steinheim, Germany) and δ-lactoglobulin (Sigma-Aldrich Chemie GmbH) at a concentration of 1 mg mL⁻¹ were prepared. Prior to injection, the solutions were stirred and filtered (0.22 mm). A 25 mL sample was injected. The absorbance was recorded at 210 and 280 nm. For all the MWP samples and standards, the total protein content was determined by the IDF Standard 20B Kjeldahl method (IDF, 1993).

A quantitative analysis of the native whey protein content was performed by comparing the peak areas obtained for the corresponding standard proteins with those of the MWP solutions. Afterwards, the denatured whey protein content of the MWPs was calculated by considering the protein content of the samples and their quantified native protein. The ratio between these two percentages was reported as the native-to-denatured whey protein ratio (N/D).

### Example 3

### Adjuvant Trials

### First Round of Trials:

Different salts were tested as adjuvants to see their influence. 13 different codes were conducted in the same basic test recipe consisting of:

| Ingredient | % by weight (% w/w) | |
|---|---|---|
| Palm kernel oil Polawar E31 | 9.00% | w/w |
| Whey protein material (WPM) | 0.86-0.89% | w/w |
| Adjuvant | 0.09-0.45% | w/w |
| MSNF (Milk Solids Non-Fat) other than protein | 7.69-8.02% | w/w |
| Sucrose + glucose | 17.35% | w/w |
| Cremodan SE 709 VEG | 0.50% | w/w |
| Water | 64.15% | w/w |
| Total input ingredients | 100% | w/w |

### Codes 1-3

1: KCl=0.09% w/w; WPM=0.89% w/w; MSNF other than protein=8.02% w/w
2: KCl=0.27% w/w; WPM=0.87% w/w; MSNF other than protein=7.86% w/w
3: KCl=0.45% w/w; WPM=0.85% w/w; MSNF other than protein=7.70% w/w

### Codes 4-6

4: NaCl=0.09% w/w; WPM=0.89% w/w; MSNF other than protein=8.02% w/w
5: NaCl=0.22% w/w; WPM=0.88% w/w; MSNF other than protein=7.90% w/w
6: NaCl=0.36% w/w; WPM=0.86% w/w; MSNF other than protein=7.78% w/w

### Codes 7-9

7: CaCl₂=0.09% w/w; WPM=0.89% w/w; MSNF other than protein=8.02% w/w
8: CaCl₂=0.18% w/w; WPM=0.88% w/w; MSNF other than protein=7.94% w/w
9: CaCl₂=0.27% w/w; WPM=0.87% w/w; MSNF other than protein=7.86% w/w

### Codes 10-12

10: Na₃-Citrate 0.09% w/w; WPM=0.89% w/w; MSNF other than protein=8.02% w/w
11: Na₃-Citrate 0.18% w/w; WPM=0.88% w/w; MSNF other than protein=7.94% w/w
12: Na₃-Citrate 0.27% w/w; WPM=0.87% w/w; MSNF other than protein=7.86% w/w

### Code 13

### Reference:

| Ingredient | % by weight (% w/w) | |
|---|---|---|
| Palm kernel oil Polawar E31 | 9.00% | w/w |
| Whey protein material | 1.35% | w/w |
| Adjuvant | 0.00% | w/w |
| MSNF (Milk Solids Non-Fat) other | 7.65% | w/w |
| than protein | | |
| Sucrose + glucose | 17.35% | w/w |
| Cremodan SE 709 VEG | 0.50% | w/w |
| Water | 64.15% | w/w |
| Total input ingredients | 100% | w/w |

### Adjuvant Trial Results (Score:1-7—the Higher the Better)

| | Meltdown after 2 | Mouth | | |
|---|---|---|---|---|
| Code | hours | feel | Creaminess | Cold-Warm |
| 1 | 65% | 2 | 2 | 2 |
| 2 | 68% | 2 | 2 | 2 |
| 3 | 63% | 2 | 2 | 2 |
| 4 | 57% | 1 | 2 | 1 |
| 5 | 59% | 2 | 1 | 1 |
| 6 | 65% | 2 | 1 | 1 |
| 7 | 81% | 2 | 2 | 2 |
| 8 | 81% | 2 | 2 | 2 |
| 9 | 84% | 3 | 2 | 2 |
| 10 | 16% | 4 | 3 | 3 |
| 11 | 15% | 4 | 4 | 4 |
| 12 | 13% | 4 | 4 | 4 |
| 13 | 60% | 4 | 4 | 4 |

The reference frozen confectionery product (Code 13) showed a meltdown after two hours of 60%, and a score of 4 out of 7 in Mouth feel, Creaminess and Cold-Warm tests. In comparison, Codes 10-12 showed a meltdown after two hours of about 15%—a clear improvement. Furthermore, Codes 10-12 were very close to or equal to the reference in the scores of the other three tests. Hence, the use of Na₃-Citrate as adjuvant was surprisingly good compared to the other tested adjuvants.

### Frozen Confectionery Product—Melting Test

If the frozen confectionery product melts easily, it indicates a watery taste and a low creaminess. A low degree of melting gives a higher creaminess due to more free fat. The free fat protects the air bubbles in the frozen confectionery product.

The melting of a frozen confectionery product was determined by the weight of the melted frozen confectionery product every 20 min. over a time period of 2 hours.

### Procedure

1. The day before the measurement, the frozen confectionery product was moved from the application freezer to the laboratory freezer (−18° C.) to temperate for 1 day.
2. Before the measurement, the weight was calibrated and the freezer and room temperatures were noted.
3. Tubs were numerated and the weight of the tubs was noted (weight tub)
4. When the frozen confectionery product sample was moved from the laboratory freezer, the timer was started.
5. The sample was unpacked and placed on a tarred wire mesh. The weight was noted as the weight of the frozen confectionery product (weight total).
6. The wire mesh with the frozen confectionery product sample was placed on top of the numerated tub.
7. Every 20 min. the weight of the tub was measured. This was noted as the weight of the melted frozen confectionery product after x minutes (weight after x minutes).

### Results

The melted frozen confectionery product was calculated as follows:

$$Melted frozen confectionery product \% = 100 \% - ( \frac{{Weight}_{total} - ( {Weight}_{after \times minutes} - {Weight}_{tub} )}{{Weight}_{total}} \cdot 100 \% )$$

The results were calculated for 0, 20, 40, 60, 80, 100, and 120 minutes.

### Materials

For this procedure, the following is required:
Thermometer
Technical weight
Wire mesh (hole size 5×5 mm)
Tub dimensions 98 mm (height)×178 mm (length)×98 mm (width); 1100 ml (volume)
Ice cream sample pack dimensions 44 mm (height)×94 mm (length)×64 mm (width).

### Viscosity Test

The viscosity of liquid products (i.e. the base composition) was measured on a rheometer (Haake rheostress) with a bob/cup system.

The measurement was performed at 5° C., since the viscosity is temperature dependent.

### Procedure

### 1. Sample Preparation

Each sample is filled into bottles during processing and placed in the laboratory cooler (5° C.) to temperate for 1 day.

### 2. Setup

Set up the program for measurement of the product on the Haake rheostress see method setup.

Install the bob/cup system. Check that the temperature of the water bath for HAAKE rheostress is set at 5° C., if not adjust the temperature.

### 3. Measuring

Only the sample that is to be analysed is removed from the cool storage, the sample bottle is gently turned upside down 3 times to homogenise the sample if it phase separated during storage. Add 40 ml sample to the cup and start the data-sampling programme. A double repetition is made.

### 4. Cleaning

When the analysis is finished, dismantle the bob/cup system and clean it with water and soap and afterwards with cold water to temperate the system before the next measurement. Wipe the bob/cup system and install it again for the next sample.

### Results

The viscosity is converted to cP values. The cP values are proportional to the viscosity. Based on the cP-value read after 90 sec. (t(seq)), an average of the double repetition is calculated. The higher cP values the higher viscosity.

### Materials

For this procedure the following is required:
Haake rheostress 1 rheometer
Bob: Z34 DIN 53019 series
Cup: Z34 DIN53018 series probes
Water bath Haake K20/Haake DC50

### Method Setup

The parameters for the programme are as follows:

Step 1: Measurement position
Step 2: Controlled Stress of 1.00 Pa for 30 sec. at 5.00° C. Frequency of 1.000 Hz. 2 data points are collected
Step 3: Controlled Rate of 50.00 μs for 120 sec. at 5.00° C. 30 data points are collected
Step 4: Lift apart

### Adjuvant Trial Results—Viscosity

| Code | Viscosity (cP) |
|---|---|
| 1 | 81 |
| 2 | 83 |
| 3 | 87 |
| 4 | 92 |
| 5 | 98 |
| 6 | 104 |
| 7 | 80 |
| 8 | 81 |
| 9 | 82 |
| 10 | 85 |
| 11 | 100 |
| 12 | 110 |
| 13 | 80 |

A viscosity of 50-200 centipoise (cP) is considered to be fine. All the trial results (Codes 1-13) were within this range.

Base composition—Viscosity

When the viscosity is medium to high in the base composition, a high overrun in the frozen confectionery product can be obtained. If the viscosity is too high, the mix is hard to handle during processing, e.g. pumping.

A high viscosity of the base composition also indicates less free water giving a stable frozen confectionery product resistant to heat shock.

### Second Round of Trials:

From the first round of trials, it was observed and concluded that the effect of tri-sodium citrate was significant.

In the next trial round, the aim was to find the optimum level of tri-sodium citrate.

The following trials were made:

### Codes 14-17

### 14: Na₃-Citrate 0.09% w/w

### 15: Na₃-Citrate 0.045% w/w

### 16: Na₃-Citrate 0.112% w/w

### 17: Na₃-Citrate 0.135% w/w

| | Codes | | | |
|---|---|---|---|---|
| | 14 | 15 | 16 | 17 |
| Viscosity | 85 | 80 | 90 | 92 |
| Meltdown | 17% | 15.7% | 14.6% | 15% |
| After 2 | | | | |
| hours | | | | |

Sensorially, it was found that code 16 was just slightly better than code 14, and a further increase in Na₃-Citrate dosage (code 17), did not give substantial better results.

| | Code 14 | Code 15 | Code 16 | Code 17 |
|---|---|---|---|---|
| Cold [symbol] Warm | 4 | 4 | 4 | 4/5 |
| Creaminess | 4 | 4 | 5 | 5 |
| Mouth feel | 4 | 4 | 5 | 5 |

### Third Round of Trials:

The third round of trials was conducted in order to test whether it was the citrate as such that had the desired properties, whether it was a combination of citrate and counter ion, or the degree of protonation.

The following trials were made:

### Codes 18-21

### 18: Naₑ-Citrate 0.135% w/w

### 19: Na₃-Citrate 0.135% w/w

### 20: K₃-Citrate 0.135% w/w

21: No adjuvant

| | Codes | | | |
|---|---|---|---|---|
| | 18 | 19 | 20 | 21 |
| Viscosity | 85 | 80 | 90 | 92 |
| (cP) | | | | |
| Meltdown | 17% | 15.7% | 14.6% | 15% |
| After 2 | | | | |
| hours | | | | |

| | Code 18 | Code 19 | Code 20 | Code 21 |
|---|---|---|---|---|
| Cold [symbol] Warm | 1 | 4/5 | 2 | 2 |
| Creaminess | 2 | 5 | 3 | 2 |
| Mouth feel | 2 | 5 | 3 | 2 |

Surprisingly, it was found that Na₃-Citrate (Code 19) performed the best results in the sensorial tests.

### Fourth Round of Trials:

The final trial was performed to determine if Na₃-Citrate could have the same effects on a frozen confectionery product comprising standard whey protein (i.e. a whey protein that has not been subjected to a microparticulation step), still tested in the same basic recipe.

Code 22: Std whey powder, no Na₃-Citrate
Code 23: Std whey powder, Na₃-Citrate 0.112% w/w
Code 24: Microparticulated whey protein (MIA10, Arla), no Na₃-Citrate
Code 25: Microparticulated whey protein (MIA10, Arla), Na₃-Citrate 0.112% w/w

| | Codes | | | |
|---|---|---|---|---|
| | 22 | 23 | 24 | 25 |
| Viscosity | 80 | 81 | 90 | 88 |
| (cP) | | | | |
| Meltdown | 87% | 78% | 71% | 15% |
| After 2 | | | | |
| hours | | | | |

| Sensorial | Code 22 | Code 23 | Code 24 | Code 25 |
|---|---|---|---|---|
| Cold [symbol] Warm | 1 | 2 | 2 | 4/5 |
| Creaminess | 2 | 2 | 3 | 5 |
| Mouthfeel | 2 | 2 | 3 | 5 |

Surprisingly, only microparticulated whey protein combined with Na₃-Citrate (Code 25) gave the desired effect/property.

### REFERENCES

Dissanayake, M., & Vasiljevic, T. (2009). Functional properties of whey proteins affected by heat treatment and hydrodynamic high-pressure shearing. Journal of Dairy Science, 92, 1387-1397.
Queguiner, C., Dumay, E., Saloucavalier, C., & Cheftel, J. C. (1992). Microcoagulation of a whey-protein isolate by extrusion cooking at acid pH. Journal of Food Science, 57, 610-616.
Schokker, E. P., Singh, H., & Creamer, L. K. (2000). Heat induced aggregation of beta-lactoglobulin A and B with alpha-lactalbumin. International Dairy Journal, 10, 843-853.
Simmons, M. J. H., Jayaraman, P., Fryer, P. J., (2007). The effect of temperature and shear rate on the aggregation of whey proteins and its implications for milk fouling. Journal of Food Engineering 79, 517-528.
Spiegel, T., & Huss, M. (2002). Whey protein aggregation under shear conditions—effects of pH-value and removal of calcium. International Journal of Food Science and Technology, 37, 559e568.

1. A method for producing a low-protein frozen confectionery product having a protein content within the range of 0.050-1.25% w/w and an edible fat content of at least 5% w/w, said method comprising the steps of:
providing a base composition comprising:
an ingredient mix comprising:
a microparticulated whey protein material having a denaturation degree within the range of 5-80%, and a calcium chelating agent
a sweetening agent
an edible fat source
an emulsifying agent, and
water
mixing said base composition to obtain an emulsified mixture and
freezing said emulsified mixture to obtain the low-protein frozen confectionery product.

2-19. (canceled)

20. The method according to claim 1, wherein the calcium chelating agent is selected from the group consisting of any salt of citrate, mono-sodium citrate, di-sodium citrate, tri-sodium citrate and disodium ethylenediaminetetraacetate dehydrate (disodium EDTA).

21. The method according to claim 2, wherein the calcium chelating agent is tri-sodium citrate.

22. The method according to claim 1, wherein the base composition further comprises an amount of calcium chelating agent in the amount of at least 0.01% w/w.

23. The method according to claim 1, wherein the weight ratio between the calcium chelating agent and the microparticulated whey protein material is within the range of 1:10 to 1:1.

24. The method according to claim 1, wherein at least 80% of the microparticulated whey protein material has a particle size within the range of 0.001-10 μm.

25. The method according to claim 1, wherein the microparticulated whey protein material is caseinoglycomacropeptide (CGMP).

26. A low-protein frozen confectionery product having a protein content within the range of 0.05 to 1.25% w/w and an edible fat content of at least 5% w/w, said frozen confectionery product comprising:
an ingredient mix comprising:
a microparticulated whey protein material having a denaturation degree within the range of 5-80%, and a calcium chelating agent;
one or more edible fat source;
one or more emulsifying agent; and
water.

27. The low-protein frozen confectionery product according to claim 26, wherein the calcium chelating agent is selected from the group consisting of any salt of citrate, mono-sodium citrate, di-sodium citrate, tri-sodium citrate and disodium ethylenediaminetetraacetate dehydrate (disodium EDTA).

28. The low-protein frozen confectionery product according to claim 26, wherein the calcium chelating agent is tri-sodium citrate.

29. The low-protein frozen confectionery product according to claim 26, wherein the calcium chelating agent is added in an amount of at least 0.01% w/w.

30. The low-protein frozen confectionery product according to claim 26, wherein the weight ratio between the calcium chelating agent and the microparticulated whey protein material is within the range of 1:10 to 1:1.

31. The low-protein frozen confectionery product according to claim 26, wherein at least 80% of the microparticulated whey protein material has a particle size distribution within the range of 0.001-10 μm.

32. The low-protein frozen confectionery product according to claim 26, wherein the microparticulated whey protein material is caseinoglycomacropeptide (CGMP).

33. An ingredient mix comprising:
a microparticulated whey protein material having a denaturation degree within the range of 5-80%;
a calcium chelating agent; and
a milk solid non-fat other than protein, wherein the weight ratio between the calcium chelating agent and the microparticulated whey protein material is within the range of 1:10 to 1:1 and wherein the weight ratio between the calcium chelating agent and the milk solid non-fat other than protein is within the range of 1:89 to 1:9.

34. An ingredient mix according to claim 33, wherein said calcium chelating agent is present in an amount of at least 1% w/w.

35. An ingredient mix according to claim 33, wherein said ingredient mix further comprising water in an amount of at most 4% w/w.

36. An ingredient mix according to claim 33, wherein at least 80% of the microparticulated whey protein material has a particle size within the range of 0.001-10 μm.

37. An ingredient mix according to claim 33, wherein the microparticulated whey protein material is caseinoglycomacropeptide (CGMP).
